(19) United States
(12) Patent Application Publication
(10) Pub. No.: US 2015/0360061 A1
(43) Pub. Date: Dec. 17, 2015

(54) Respirator That Uses A Predefined Curved Nose Foam

(71) Applicant: 3M INNOVATIVE PROPERTIES COMPANY, St. Paul, MN (US)

(72) Inventor: Suresh Kalatoor, Cottage Grove, MN (US)

(21) Appl. No.: 14/833,303

(22) Filed: Aug. 24, 2015

Related U.S. Application Data
(63) Continuation of application No. 11/459,949, filed on Jul. 26, 2006, now abandoned.

(51) Int. Cl. A62B 23/02; A62B 9/06

(52) U.S. Cl. CPC A62B 23/025; A62B 9/06

(57) ABSTRACT

A respirator that has a mask body and a nose foam, the mask body being adapted to fit over the nose and mouth of a person and having an interior surface that curves concave downward in the nose region of the mask body. The nose foam has first and second opposing major surfaces and a thickness T that extends from the first major surface to the second major surface. The first major surface of the nose foam is secured to the interior surface of the mask body in the nose region, and the opposing second major surface of the nose foam is available for making substantial contact with a person's nose when the mask body is placed on a person's face. At least the first major surface of the nose foam has a predefined downward concave curvature. A nose foam that is pre-shaped in this manner has less opportunity to become pinched or unnecessarily deformed before being placed on a wearer's face.

The present invention pertains to a respiratory mask that has a nose foam that is preconfigured into a curved shape on at least one major surface of the nose foam.

### BACKGROUND

Respirators (sometimes referred to as “filtering face masks” or “filtering face pieces”) are generally worn over the breathing passages of a person for two common purposes: (1) to prevent impurities or contaminants from entering the wearer's respiratory system; and (2) to protect other persons or things from being exposed to pathogens and other contaminants exhaled by the wearer. In the first situation, the respirator is worn in an environment where the air contains particles that are harmful to the wearer, for example, in an auto body shop. In the second situation, the respirator is worn in an environment where there is risk of contamination to other persons or things, for example, in an operating room or clean room.

To meet either of these purposes, the mask body of the respirator must be able to maintain a snug fit to the wearer's face. Known mask bodies can, for the most part, match the contour of a person's face over the cheeks and chin. In the nose region, however, there is a radical change in contour, which makes a snug fit more difficult to achieve. The failure to obtain a snug fit can be problematic in that air can enter or exit the respirator interior without passing through the filter media. When this happens, contaminants may enter the wearer's breathing track, and other persons or things may become exposed to contaminants exhaled by the wearer. In addition, a wearer's eyeglasses can become fogged when the exhalate escapes from the respirator interior over the nose region. Fogged eyewear, of course, makes visibility more troublesome to the wearer and creates unsafe conditions for the user and others.

Nose foams have been used on respirators to assist in achieving a snug fit over the wearer's nose. Nose foams also may improve wearer comfort. Conventional nose foams are typically in the form of compressible strips of foam—see, for example, U.S. Pat. Nos. 6,923,182, 5,765,556, and U.S. Published Application 2005/0211251. The nose foam is commonly used in conjunction with a conformable nose clip to obtain the snug fit—see, for example, U.S. Pat. Nos. 5,558,089, 5,307,796, 4,600,002, 3,603,315, and Des. 412,573 and British Patent GB 2,103,491.

Although known nose foams are able to help provide a snug fit over the wearer's nose, the nose foams are not cut to match the interior contour of the mask body. Known nose foams are often cut into a three-dimensional, linearly-shaped geometry. As such, the nose foam can become pinched in one or more locations when bent to accommodate the curved shape of the mask body. And because a person's nose exhibits a radical curvature, known nose foams are often designed to be sufficiently thick to achieve a good seal when conformed about a wearer's nose. Thick nose foams, however, have a greater tendency to exhibit noticeable pinching or compaction when secured to the mask body.

### SUMMARY OF THE INVENTION

The present invention provides a respirator that comprises: (a) a mask body that is adapted to fit over the nose and mouth of a person and that has an interior surface that curves concave downward in the nose region thereof; and (b) a nose foam that has first and second opposing major surfaces and a thickness T that extends from the first major surface to the second major surface. The first major surface of the nose foam is secured to the interior surface of the mask body in the nose region, and the opposing second major surface of the nose foam is positioned for making substantial contact with a person's nose when the mask body is placed on a person's face. The first major surface of the nose foam has a predefined downward concave curvature.

The present invention differs from known respirators in that the nose foam has a first major surface that has a predefined curvature. Preferably, this predefined curvature is substantially the same as the curvature of the mask body interior at the location where the nose foam secured to the mask body. Applicants discovered that if the nose foam is provided with such a predefined curvature, that the nose foam is less likely to become pinched in the center or elsewhere along its length. Preferably, the second major surface of the nose foam also has a predefined downward concave curvature. By pre-shaping the nose foam in this manner, there may be less deformation or crunching of the foam to achieve a snug fit over the wearer's nose. And, there may be less opportunity for a leak to occur in the nose region of the mask body.

These and other advantages of the invention are more fully shown and described in the drawings and detailed description of this invention, where like reference numerals are used to represent similar parts. It is to be understood, however, that the drawings and description are for illustration purposes only and should not be read in a manner that would unduly limit the scope of this invention.

### GLOSSARY

The terms set forth below will have the meanings as defined:

“aerosol” means a gas that contains suspended particles in solid and/or liquid form;

“clean air” means a volume of atmospheric ambient air that has been filtered to remove contaminants;

“comprises (or comprising)” means its definition as is standard in patent terminology, being an open-ended term that is generally synonymous with “includes”, “having”, or “containing” Although “comprises”, “includes”, “having”, and “containing” are commonly-used, open-ended terms, this invention also may be described using narrower terms such as “consists essentially of”, which is semi open-ended term in that it excludes only those things or elements that would have a deleterious effect on the performance of the nose foam in serving its intended function;

“contaminants” means particles (including dusts, mists, and fumes) and/or other substances that generally may not be considered to be particles (e.g., organic vapors, et cetera) but which may be suspended in air, including air in an exhale flow stream;

“crosswise dimension” is the dimension that extends across a wearer's nose when the respirator is worn; it is synonymous with the “length” dimension of the nose foam;

“exhalation valve” means a valve that has been designed for use on a respirator to open unidirectionally in response to pressure or force from exhaled air;

“exhaled air” is air that is exhaled by a respirator wearer;

“exterior gas space” means the ambient atmospheric gas space into which exhaled gas enters after passing through and beyond the mask body and/or exhalation valve;

“filter media” means an air-permeable structure that is capable of removing contaminants from air that passes through it;

“first major surface” means a surface of nose foam that has sufficient surface area to enable adequate securement of the nose foam to an interior surface of the mask body;

“harness” means a structure or combination of parts that assists in supporting the mask body on a wearer's face;

“interior gas space” means the space between a mask body and a person's face;

“lengthwise dimension” means the direction of the length (long axis) of the nose foam (which extends across the bridge of the wearer's nose when the mask is worn);

“malleable” means deformable in response to mere finger pressure;

“mask body” means an air-permeable structure that can fit at least over the nose and mouth of a person and that helps define an interior gas space separated from an exterior gas space;

“memory” means that the deformed part has a tendency to return to its preexisting shape after deforming forces have ceased;

“midsection” is the central part of the nose foam that extends over the bridge or top of a wearer's nose;

“non-integral”, in reference to the nose foam, means made separately from;

“nose clip” means a mechanical device (other than a nose foam), which device is adapted for use on a filtering face mask to improve the seal at least around a wearer's nose;

“nose foam” means a compressible porous material that is adapted for placement on the interior of a mask body to improve the fit and/or comfort over the nose when the respirator is worn;

“nose region” means the portion of the mask body that resides over a person's nose when the respirator is worn;

“particles” means any liquid and/or solid substances that is capable of being suspended in air, for example, dusts, mists, fumes, pathogens, bacteria, viruses, mucous, saliva, blood, etc.;

“polymer” means a material that contains repeating chemical units, regularly or irregularly arranged;

“polymeric and plastic” means that the material mainly includes one or more polymers and may contain other ingredients as well;

“porous” means a mixture of a volume of solid material and a volume of voids, which mixture defines a three-dimensional system of interstitial, tortuous channels through which a gas can pass;

“portion” means part of a larger thing;

“predefined” means that the curvature is disposed on the nose foam as a result of its manufacture and not as a result of its placement on the mask body;

“radius of curvature” the amount of curvature of a shape. The term is often followed by a quantity that describes the radius of a circle whose circumference would match the shape being described;

“respirator” means a device that is worn by a person to filter air before the air enters the person's respiratory system;

“second major surface” means a surface of the nose foam that is sized to be sufficiently large to enable the nose foam to make adequate contact with a wearer's nose when the respirator is being worn;

“shape-retainable” means that the shape is substantially retained after any deforming forces have ceased;

“snug fit” or “fit snugly” means that an essentially air-tight (or substantially leak-free) fit is provided (between the mask body and the wearer's face);

“thermoplastic” means a polymer that may be softened by heat and hardened by cooling in a reversible physical process; and

“transverse dimension” means the dimension that extends at a right angle to the lengthwise dimension (and along the length of the wearer's nose when worn).

### BRIEF DESCRIPTION OF THE DRAWINGS

FIG. 1 is a front view of a foam block 10 that illustrates how multiple nose foams 12 can be cut therefrom into predefined arcuate shapes;

FIG. 2a is a front view of predefined arcuate nose foam 12;

FIG. 2b is a top view of an arcuate nose foam 12 taken in the direction of arrow A noted in FIG. 2a;

FIGS. 3a-3c are perspective views of three different nose foam embodiments 12, 12′, and 12″;

FIG. 4 is a rear view of a respirator 24 that has a nose foam 12 located on an interior surface 18 of the mask body 20; and

FIG. 5 is a cross-section of mask body 20.

### DETAILED DESCRIPTION OF PREFERRED EMBODIMENTS

In describing preferred embodiments of the invention, specific terminology is used for clarity sake. The invention, however, is not intended to be limited to the specific terms so selected, and each term so selected includes all technical equivalents that operate similarly.

In practicing the present invention, a new respirator is provided that has a nose foam with a predefined downward concave curvature on the first major surface. The nose foam may also be configured on its first major surface to have a curvature that generally matches the interior concave downward curvature of the respirator mask body. When the nose foam is cut or otherwise fashioned into such a predefined shape, the foam is less likely to exhibit a pinching or compaction in one or more locations along the length of the nose foam when it is placed on the interior of the mask body. Before the present invention, conventional nose sealing foams had often been cut in a generally linear configuration that bore no relation to the curvature of the mask body interior. As such, the nose foams were susceptible to becoming compressed when they were bent to accommodate the shape of the mask body interior. The present invention, thus, may reserve nose foam compaction for accommodating the shape of the wearer's nose when the mask is worn.

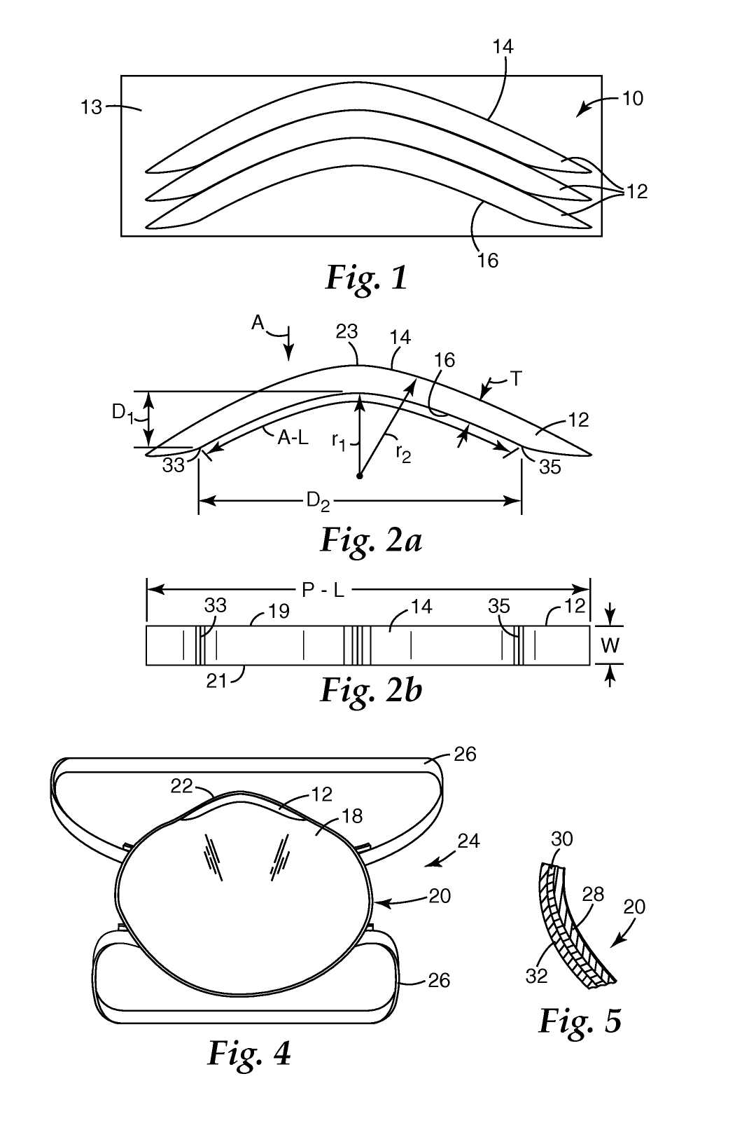

FIG. 1 shows a nose foam block 10 from which a plurality of predefined, arcuate nose foams 12 may be cut. In previous techniques for manufacturing nose foams, the nose foams 12 were cut as linear strips that extended across the nose foam block 10. As shown in FIG. 1, the nose foams 12 are cut such that the inner cut of one nose foam also defines the outer cut of an adjacent nose foam. When the nose foams are cut in this manner, no waste is produced between adjacent nose foams. Waste may be created on the sides 13 of the block 10 but not between each adjacent nose foam 12. Although FIG. 1 shows multiple nose foams being cut from a single block of foam, the nose foams may be fashioned in other ways such as by individually molding each nose foam into the appropriate shape.

FIG. 2a further illustrates the nose foam 12 and its first and second opposing major surfaces 14 and 16, respectively. The opposing major surfaces 14 and 16 are separated from each other by the thickness T of the nose foam. The first major surface 14 would be secured to the interior surface 18 of mask body 20 in its nose region 22 (FIG. 4). The second major surface 16 of the nose foam 12 is available for making substantial contact with the wearer's nose when the respirator 24 (FIG. 4) is donned. As shown in FIG. 2a, the nose foam 12 has a predefined downward concave curvature. The curvature is particularly pronounced in the center region 23 and may be defined by radius r₁ and r₂. The first radius r₁ defines the radius of the inner curvature of the nose foam 12, and the second radius r₂ defines the curvature of the outer surface of the nose foam 12 when viewed from the side elevation. The second major surface 16 may have an arc length A-L. In a preferred embodiment, the dimensions of r₁ generally range from about 1.5 to 75 millimeters (mm), more typically about 2 to 50 mm. The dimensions of r₂ generally range are about r₁ plus the thickness of the nose foam. The path length of the nose foam A-L on its interior surface typically is about 4 to 10 centimeters (cm), more typically about 7 to 9 cm. The thickness of the nose foam T generally is greater than about 3 mm and may be up to about 15 mm, more typically greater than about 4 or 5 mm up to about 10 mm.

As shown in FIG. 2b, the nose foam 12 has the total projected lengthwise dimension P-L and a width W. The projected lengthwise dimension P-L is generally about 3 to 9 cm, more commonly about 5 to 8 cm. The width W generally is about 0.5 to 3 cm, more typically about 0.8 to 2 cm. The width W is the distance between the first and second side surfaces 19 and 21, respectively, of the nose foam 12.

The nose foam can be made from a variety of materials such a polyurethane, polyvinylchloride, polyolefin such as polypropylene and polyethylene, polyethylene vinyl acetate, rubber (natural or synthetic) such as polyisoprene, or combinations thereof. The nose foam could be made from an open cell or closed cell foam. Microcellular foams may also be used. The nose foam could use essentially any compressible material (now known or later developed) that adapts to the shape of a person's nose.

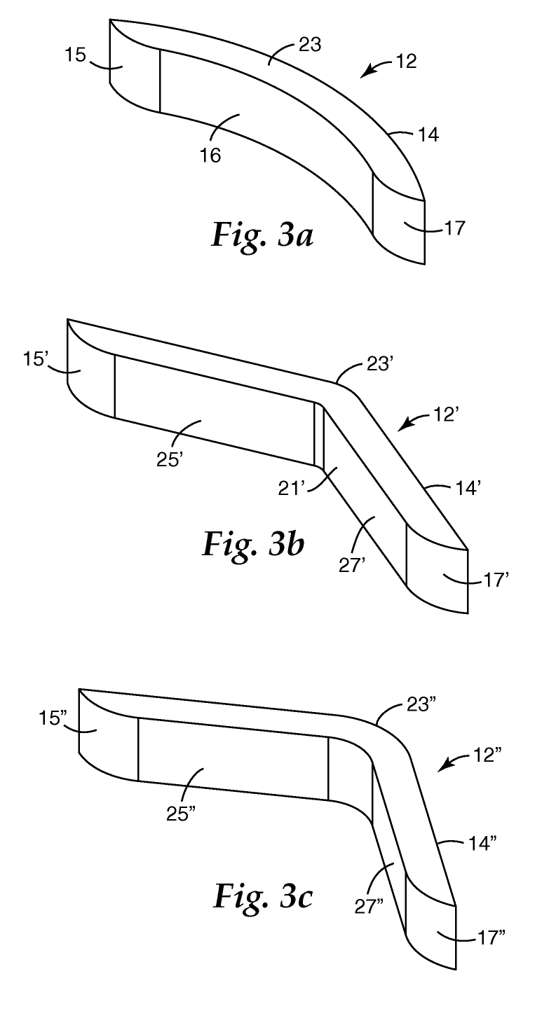

FIGS. 3a-3c show three different embodiments of a nose foam element 12, 12′, and 12″. Each nose foam has a first major surface 14, 14′, and 14″, and a second major surface 16, 16′, and 16″. The embodiment shown in FIG. 5a has a generally constant curvature over the first and second major surfaces and has first and second tapered ends 15 and 17. These tapered ends are also present in the embodiments shown in FIGS. 3b and 3c as 15′, 15″, and 17′, 17″, respectively. In the embodiments shown in FIG. 3b, the nose foam has first and second straight portions 25′ and 27′ and has a tightly curved central portion 23′. In FIG. 3c, the central portion 23″ does not have as tight a radius as the central portion 23′ shown in FIG. 3b. The particular arc that is used on the first major surface 14, 14′, and 14″ may vary as shown in FIGS. 3a-3c. The configuration of the arc may vary depending on the interior shape of the mask body. As indicated above, it is preferred, but not necessary, that the first major surface more closely follows the interior of the mask body in the nose region. When the first major surface 14, 14′, and 14″ more closely matches the interior surface of the mask body in the nose region, there may be less opportunity for the nose foam to become pinched or unnecessarily compacted, particularly in the center of the nose foam 23, 23′, or 23″.

FIG. 4 shows a respirator mask 24 that includes a mask body 20 and the nose foam 12. The nose foam 12 exhibits a concave downward curvature when viewing the mask in an upright position as shown in FIG. 4. The nose foam 12 can be secured to the mask body 20 by applying an adhesive to the first major surface 14 of the nose foam 12 or to the interior of the mask body 20 or both. The adhesive could be, for example, a pressure-sensitive or hot-melt adhesive and could be applied as a coating or by spraying. Essentially any adhesive or other suitable means of securement, ultrasonic welding, for example, could be used to fasten the foam 12 to the mask body 20 interior 18. Mask body 20 is adapted to fit over the nose and mouth of a person in a spaced relation to a wearer's face to create an interior gas space or void between the wearer's face and the interior surface 18 of the mask body 20. The mask body 20 may be of a curved, hemispherical, cup-shape such as shown in FIG. 3—see also U.S. Pat. No. 4,536,440 to Berg, U.S. Pat. No. 4,807,619 to Dyrud et al., and U.S. Pat. No. 5,307,796 to Kronzer et al. The respirator body also may take on other shapes as so desired. For example, the mask body can be a cup-shaped mask having a construction as shown in U.S. Pat. No. 4,827,924 to Japuntich. The mask body also may be a flat-folded product like the bi-fold and tri-fold mask products disclosed in U.S. Pat. Nos. 6,722,366 and 6,715,489 to Bostock, U.S. Pat. Nos. D459,471 and D458,364 to Curran et al., and U.S. Pat. Nos. D448,472 and D443,927 to Chen. See also U.S. Pat. Nos. 4,419,993, 4,419,994, 4,300,549, 4,802,473, and Re. 28,102. The respiratory 24 may include a malleable nose clip that can be conformed to the shape of the wearer's nose. The nose clip may be made from a metal or plastic material that retains its deformed shape after being manually conformed. Examples of nose clips are shown in U.S. Pat. Nos. 5,558,089 and D412,573 to Castiglione, and in U.S. Ser. No. 11/236,283 to Kalatoor et al. Because the mask body shape at the nose region tends to be dictated by the shape of the nose clip, the nose foam curvature may be provided to generally match the curvature of the nose clip. The mask body may include one or more layers of filter media. Commonly, a nonwoven web of electrically-charged microfibers i.e., fibers having an effective diameter of about 25 micrometers (μm) or less (typically about 1 to 15 μm)—is used as a layer of filter media. Filter media can be charged according to U.S. Pat. No. 6,119,691 to Angadjivand et al. Essentially any presently known (or later developed) mask body that is air permeable and that includes a layer of filter media could be used in connection with this invention.

As shown in FIG. 4, the respirator 24 also includes a harness such as straps 26 that are sized to pass behind the wearer's head to assist in providing a snug fit to the wearer's face. The straps 26 preferably are made of an elastic material that causes the mask body 24 to exert a slight pressure on the wearer's face. A number of different materials may be suitable for use as straps 26, for example, the straps may be formed from a thermoplastic elastomer that is ultrasonically welded to the respirator body 20. Ultrasonic welding may be beneficial over the use of staples to fasten the harness to the mask body since metal is not used. The 3M 8210™ particulate respirator is an example of a filtering face mask that employs ultrasonically welded straps. Woven cotton elastic bands, rubber cords (e.g. polyisoprene rubber) and/or strands also may be used, as well as non-elastic adjustable straps—see U.S. Pat. No. 6,705,317 to Castiglione and U.S. Pat. No. 6,332,465 to Xue et al. Other examples of mask harnesses that may be used in connection with the present invention are shown in U.S. Pat. Nos. 6,457,473B1, 6,062,221, and 5,394,568, to Brostrom et al., U.S. Pat. Nos. 6,591,837, 6,119,692 and 5,464,010 to Byram, and U.S. Pat. Nos. 6,095,143 and 5,819,731 to Dyrud et al. Essentially any strap system (presently known or later-developed) that is fashioned for use in supporting a respiratory face piece on a wearer's head could be used as a harness in connection with the present invention. The harness also could include a head cradle in conjunction with one or more straps for supporting the mask. The respirator also can have an exhalation valve located thereon such as the unidirectional fluid valve disclosed in U.S. Pat. No. 6,854,463 to Japuntich et al. An exhalation valve allows exhaled air to escape from the interior gas space without having to pass through the filter media in the mask body 20. The exhalation valve can be secured to the mask body through use of an adhesive—see U.S. Pat. No. 6,125,849 to Williams et al.—or by mechanical clamping—see U.S. Pat. No. 6,604,524 to Curran et al. The illustrated mask body 20 is air permeable and may be provided with an opening (not shown) that is located where an exhalation valve would be attached to the mask body 20 so that exhaled air can rapidly exit the interior gas space through the exhalation valve. The preferred location of the opening on the mask body 20 is directly in front of where the wearer's mouth would be when the mask is being worn. The placement of the opening, and hence the exhalation valve, at this location allows the valve to open more easily in response to the force or momentum from the exhale flow stream. For a mask body 20 of the type shown in FIG. 1, essentially the entire exposed surface of mask body 20 is air permeable to inhaled air.

The mask body may be spaced from the wearer's face, or it may reside flush or in close proximity to it. In either instance, the mask body helps define an interior gas space into which exhaled air passes before leaving the mask interior through the exhalation valve. The mask body also could have a thermochromic fit-indicating seal at its periphery to allow the wearer to easily ascertain if a proper fit has been established—see U.S. Pat. No. 5,617,849 to Springett et al.

FIG. 5 shows that the mask body 20 may comprise multiple layers, including an inner stiffening or shaping layer 28, a filtration layer 30, and an outer cover web 32. The inner stiffening or shaping layer 28 provides structure to the respirator body 20 and support for the filtration layer 30. The shaping layer 28 can be located on the inside and/or outside of the filtration layer 30 and can be made, for example, from a non-woven web of thermally-bondable fibers that have been molded into, for example, a cup-shaped configuration by, for example, the method taught in U.S. Pat. No. 5,307,796 to Kronzer et al. A shaping layer 28 also could be made from a molded plastic net—see U.S. Pat. No. 4,850,347 to Skov. Although the shaping layer is designed with the primary purpose of providing structure to the mask and providing support for a filtration layer, the shaping layer also may act as a filter, typically for capturing larger particles suspended in the exterior gas space, if disposed outside of the filter layer. Together the shaping and filtration layers may operate as an inhale filter element. When a wearer inhales, air is drawn through the mask body, and airborne particles become trapped in the interstices between the fibers, particularly the fibers in the filter layer. In the embodiment shown in FIG. 4, the filter layer 30 is “integral” with the mask body 20—that is, it forms part of the mask body and is not an item that subsequently becomes attached to (or removed from) the mask body like a filter cartridge.

Filtering materials that are commonplace on negative pressure half mask respirators—like the filtering face mask 24 shown in FIG. 4—often contain an entangled web of electrically charged microfibers, particularly meltblown microfibers (BMF). Microfibers typically have an average effective fiber diameter of about 20 to 25 micrometers (μm) or less, but commonly are about 1 to about 15 μm, and still more commonly be about 3 to 10 μm in diameter. Effective fiber diameter may be calculated as described in Davies, C. N., The Separation of Airborne Dust and Particles, Institution of Mechanical Engineers, London, Proceedings 1B. 1952. BMF webs can be formed as described in Wente, Van A., Superfine Thermoplastic Fibers in Industrial Engineering Chemistry, vol. 48, pages 1342 et seq. (1956) or in Report No. 4364 of the Naval Research Laboratories, published May 25, 1954, entitled Manufacture of Superfine Organic Fibers by Wente, Van A., Boone, C. D., and Fluharty, E. L. Meltblown fibrous webs can be uniformly prepared and may contain multiple layers, like the webs described in U.S. Pat. Nos. 6,492,286B1 and 6,139,308 to Berrigan et al. When in the form of a randomly entangled web, BMF webs can have sufficient integrity to be handled as a mat. Electric charge can be imparted to fibrous webs using techniques described in, for example, U.S. Pat. Nos. 6,454,986B1 and 6,406,657B1 to Eitzman et al.; U.S. Pat. Nos. 6,375,886B1, 6,119,691 and 5,496,507 to Angadjivand et al., U.S. Pat. No. 4,215,682 to Kubik et al., and U.S. Pat. No. 4,592,815 to Nakao.

Examples of fibrous materials that may be used as filters in a mask body are disclosed in U.S. Pat. No. 5,706,804 to Baumann et al., U.S. Pat. No. 4,419,993 to Peterson, U.S. Reissue Pat. No. Re 28,102 to Mayhew, U.S. Pat. Nos. 5,472,481 and 5,411,576 to Jones et al., and U.S. Pat. No. 5,908,598 to Rousseau et al. The fibers may contain polymers such as polypropylene and/or poly-4-methyl-1-pentene (see U.S. Pat. No. 4,874,399 to Jones et al. and U.S. Pat. No. 6,057,256 to Dyrud et al.) and may also contain fluorine atoms and/or other additives to enhance filtration performance—see, U.S. Pat. Nos. 6,432,175B1, 6,409,806B1, 6,398,847B1, 6,397,458B1 to Jones et al. and U.S. Pat. Nos. 5,025,052 and 5,099,026 to Crater et al., and may also have low levels of extractable hydrocarbons to improve performance—see U.S. Pat. No. 6,213,122 to Rousseau et al. Fibrous webs also may be fabricated to have increased oily mist resistance as described in U.S. Pat. No. 4,874,399 to Reed et al., and in U.S. Pat. Nos. 6,238,466 and 6,068,799, both to Rousseau et al. The filtration layer optionally could be corrugated as described in U.S. Pat. Nos. 5,804,295 and 5,763,078 to Braun. The mask body also can include an outer cover web to protect the filtration layer. The cover web may be made from nonwoven webs of BMF as well, or alternatively from webs of spunbond fibers. An inner cover web also could be used to provide the mask with a soft comfortable fit to the wearer's face—see U.S. Pat. No. 6,041,782 to Angadjivand et al. The cover webs also may have filtering abilities, although typically not nearly as good as the filtering layer.

The following Example has been selected merely to further illustrate features, advantages, and other details of the invention. It is to be expressly understood, however, that while the Examples serve this purpose, the particular ingredients and amounts used as well as other conditions and details are not to be construed in a manner that would unduly limit the scope of this invention.

### EXAMPLE

A nose foam of the invention was constructed and attached to a mask body. The nose foam included a reticulated flexible polyester polyurethane foam manufactured by Foamex International Inc., Linwood, Pa. under the brand SIF™. The foam had a nominal density of 26 kilograms per cubic meter (kg/m³), tensile strength of 173 Kilo Pascals (kPa), tear strength of 525 Newtons per meter (N/m) as determined in accordance with ASTM D 3574. The pore texture of the foam was nominally 195 cells per 10 lineal centimeters. The nose foam was formed from a 7.9 mm thick foam sheet that had a pressure sensitive adhesive applied to one face. The adhesive was acrylic based, was manufactured by the 3M Company, and was manually applied to one face of the cut nose foam. The foam sheet was then placed onto a cutting surface and was cut using a steel rule die cutting tool. The cut nose foam was then removed from the cutting tool, resulting in an arced, annulus-section, part that mirrored the contour of the cutting tool. The shape of the cut nose foam is generally depicted in FIGS. 2 and 3a. The inner arc of the annulus section had a radius of curvature, r₁ as depicted in FIG. 2 of 43.2 mm, with a corresponding outer arc radius of curvature, r₂, of 48.2 mm. The path length A-L at radius of curvature r₁ along the inner arc from point 33 to point 35 was 90 mm long. The projected length P-L was 57.3 mm. Each end of the nose seal foam had a rounded end having a radius of 10 mm.

The above-described nose foam was affixed to a commercially available 8511™ particulate respirator manufactured by the 3M Company, St. Paul, Minn. The sole modification to the respirator was that the original nose foam and nose clip were removed, and the inventive nose foam replaced the original nose foam. The inventive nose foam was attached to the inner surface of the respirator cup using an adhesive that was applied to the first major surface of the nose foam. The nose foam was positioned in the same general location on the respirator cup as the original nose foam. The inner arc of the nose foam, as defined by curvature of radius r₁, was oriented to face the interior surface of the respirator cup. The arcuate shape of the first major surface of the nose foam allowed it to follow the arc of the inner surface of the respirator cup without visually noticeable deformation or pinching of the nose foam.

This invention may take on various modifications and alterations without departing from its spirit and scope. Accordingly, this invention is not to be limited to the above-described but is to be controlled by the limitations set forth in the following claims and any equivalents thereof.

This invention may be suitably practiced in the absence of any element not specifically disclosed herein.

All patents and patent applications cited above, including those in the Background section, are incorporated by reference into this document in total. To the extent there is a conflict or discrepancy between the disclosure in such incorporated document and the above specification, the above specification will control.

1-19. (canceled)

20. A method of manufacturing a respirator comprising:
providing a mask body that is adapted to fit over the nose and mouth of a person and that has an interior surface comprising a curvature that curves concave downward in a nose region thereof;
providing a nose foam that has first and second opposing major surfaces and a thickness T that extends from the first major surface to the second major surface, wherein at least the first major surface is manufactured with a predefined downward concave curvature; and
securing the first major surface of the nose foam to the interior surface of the mask body in the nose region, wherein the opposing second major surface of the nose foam is positioned for making substantial contact with a person's nose when the mask body is placed on a person's face.

21. The method of claim 20, wherein the thickness T is at least about 3 mm.

22. The method of claim 20, wherein the predefined downward concave curvature of the first major surface of the nose foam is substantially the same as the curvature of the mask body interior where the nose foam is secured thereto.

23. The method of claim 20, wherein the second major surface of the nose foam has a predefined downward concave curvature.

24. The method of claim 20, wherein the nose foam is non-integral to the mask body.

25. The method of claim 20, wherein the first major surface of the nose foam is defined by radius r₁ of about 2 to 50 mm.

26. The method of claim 20, wherein the second major surface of the nose foam has an arc length A-L of about 4 to 10 cm.

27. The method of claim 20, wherein the nose foam comprises polyurethane, polyvinylchloride, polypropylene, polyethylene, polyethylene vinyl acetate, rubber, or a combination thereof, wherein the nose foam is an open cell or closed cell foam or is a microcellular foam, and wherein the mask body comprises a plurality of layers, wherein at least one of the layers is a fibrous filtration layer, and wherein the mask body has a nose clip and a harness secured thereto.

28. The method of claim 20, wherein the thickness T is greater than about 3 mm and is less than about 15 mm.

29. The method of claim 28, wherein the thickness T is greater than about 4 mm and is less than about 10 mm, and wherein a width W of the nose foam is about 0.5 cm to about 3 cm.
